(19) United States
(12) Patent Application Publication
(10) Pub. No.: US 2019/0211997 A1
(43) Pub. Date: Jul. 11, 2019

(54) LIGHTING DEVICE WITH ADJUSTABLE UPLIGHT BARS

(71) Applicant: Truly Green Solutions, Inc., Chatsworth, CA (US)

(72) Inventor: BLAKE THOMAS MURPHY, Chatsworth, CA (US)

(21) Appl. No.: 16/242,971

(22) Filed: Jan. 8, 2019

Related U.S. Application Data
(60) Provisional application No. 62/614,731, filed on Jan. 8, 2018.

(51) Int. Cl. F21V 17/02; F21V 29/70; F21V 23/00; F21V 11/00; F21S 8/04; F21V 15/01

(52) U.S. Cl. CPC F21V 17/02; F21V 29/70; F21V 23/003; F21Y 2115/10; F21S 8/04; F21V 15/01; F21V 11/00

(57) ABSTRACT

Devices described in the present disclosure can include a lighting device with adjustable uplight bars. In one embodiment, the adjustable uplight bars can comprise a plurality of light sources configured to display emitted light upwards and can be connected to an arm by an elbow joint, such that the adjustable uplight bars can rotate. In another embodiment, the adjustable uplight bars can comprise a plurality of optic caps placed over the plurality of light sources to produce a desired beam spread pattern for the emitted light. Therefore, each uplight bar can be individually customized to accommodate different positions of the lighting device in relation to the ceiling. In yet another embodiment, the adjustable uplight bars can be configured to project an image onto a surface such as a ceiling, allowing graphics to be displayed.

This application claims the benefit of U.S. Provisional Patent Application Ser. No. 62/614,731, filed on Jan. 8, 2018.

### BACKGROUND

### Field

The present disclosure relates generally to lighting devices, and more particularly to lighting devices with adjustable uplight bars comprising novel and improved structural features that provide the ideal type and amount of uplight to satisfy any application.

### Description of the Related Art

Industrial or commercial buildings are often illuminated by free-standing lighting fixtures that may be suspended from the ceiling. Certain types of commercial or industrial environments, such as store aisles or warehouses, require lighting that is designed to provide a high degree of luminosity, while still maintaining control over glare. The type of lighting fixture that satisfies these requirements is commonly referred to as bay lighting. High bay lighting is commonly referred to as bay lighting high from the ground.

In order to sufficiently illuminate this type of environment, a high bay lighting fixture with a high intensity discharge can be used. Solid state lighting devices, such as light emitting diodes (LEDs), can be used as light sources which provide longer life spans and lower power consumption. As such, LED high bay retrofitting is one of the most cost effective energy savings programs to implement in warehouses, manufacturing facilities, airplane hangars, and other commercial/industrial applications.

There are a wide variety of LED high bay solutions designed for many types of applications. While they can be effective at lighting the application area/work plane, they do not have any options to provide adjustable upward lighting to the ceiling. Without any upward lighting, a visual phenomenon known as the “cave effect” develops, which is shown in FIG. 1.

Around 5-10% uplight is common for most LED high bay lights and there are some high bays that offer fixed up light output characteristics. While these designs allow for some uplight, they provide no method in which to direct the light or place the light in the appropriate area. There is no adjustability. This is problematic because high bays are hung in a variety of different areas within a building and hung a variety of different distances from the ceiling.

### SUMMARY

The present disclosure relates to novel and improved light fixtures with adjustable uplight bars that can provide the ideal type and amount of uplight to satisfy any application. Embodiments described in the present disclosure can allow the lighting device to provide adjustable upward lighting to the ceiling, increasing the overall area lit around the lighting device, brightening the place where the lighting device is used. The adjustable uplight bars can be maneuvered to change the uplight points and can be individually customized with different beam spread patterns, which provides the advantage of accommodating different areas where the lighting device is used. Additional embodiments described in the present disclosure can allow the uplight bars to project an image, such as a pattern, phrase, or design, onto a ceiling or wall, for example.

One embodiment described in the present disclosure can include a lighting device comprising a heat sink, a removable surface panel, and a mounting mechanism connected to the removable surface panel. The mounting mechanism can be configured such that the lighting device extends vertically downwards from a ceiling. At least one arm can be connected to the heat sink and at least one uplight bar can be connected to the at least one arm by an elbow joint, such that the at least one uplight bar rotates.

Another embodiment described in the present disclosure can include a lighting device comprising a heat sink, a removable surface panel, and a mounting mechanism connected to the removable surface panel. The mounting mechanism can be configured such that the lighting device extends vertically downwards from a ceiling. At least one arm can be connected to the heat sink and at least one uplight bar can be connected to the at least one arm, wherein the at least one uplight bar can comprise a plurality of light sources configured to display emitted light upwards and a plurality of optic caps that can be placed over the plurality of light sources to produce a desired beam spread pattern for the emitted light.

Yet another embodiment described in the present disclosure can include a lighting device comprising a heat sink, a removable surface panel, and a mounting mechanism connected to the removable surface panel. The mounting mechanism can be configured such that the lighting device extends vertically downwards from a ceiling. At least one arm can be connected to the heat sink and at least one uplight bar can be connected to the at least one arm, wherein the at least one uplight bar further comprises a stencil that is placed inside the plurality of light sources to control the shape of the emitted light.

These and other further features and advantages provided in this disclosure would be apparent to those skilled in the art from the following detailed description, taken together with the accompanying drawings.

### BRIEF DESCRIPTION OF THE DRAWINGS

FIG. 1 is a perspective view of a traditional lighting device;

FIG. 2A is a side view of one embodiment of a lighting device as described in the present disclosure;

FIG. 2B is a close-up side view of the lighting device in FIG. 2A;

FIG. 3 is a perspective view of one embodiment of an adjustable uplight bar as described in the present disclosure;

FIG. 4 is top view of another embodiment of an adjustable uplight bar as described in the present disclosure;

FIG. 5 is a side view of another embodiment of an adjustable uplight bar as described in the present disclosure;

FIG. 6 is a side view of another embodiment of a lighting device as described in the present disclosure;

FIG. 7 is a top view of another embodiment of an adjustable uplight bar as described in the present disclosure;

FIG. 8A is a side view of another embodiment of a lighting device as described in the present disclosure;

FIG. 8B is a side view of another embodiment of a lighting device as described in the present disclosure;

FIG. 8C is a side view of another embodiment of a lighting device as described in the present disclosure;

FIG. 9A is a perspective view of another embodiment of an adjustable uplight bar as described in the present disclosure;

FIG. 9B is a perspective view of the adjustable uplight bar in FIG. 9A; and

FIG. 10 is a perspective view of another embodiment of an adjustable uplight bar as described in the present disclosure.

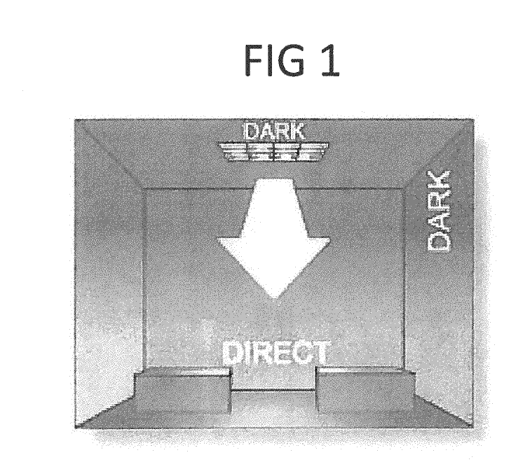

### DETAILED DESCRIPTION

Devices described herein can comprise novel and improved designs and layouts for lighting devices with adjustable uplight bars, which allow for the ideal type and amount of uplight to satisfy any application. Embodiments described in the present disclosure can comprise a lighting device with adjustable uplight bars which can be connected to the lighting device by arms with an elbow joint such that the uplight bars can rotate, allowing users to maneuver the uplight points as they desire. For example, the uplight bars can be maneuvered to accommodate different mounting areas, such as being near a side wall or corner of a building.

Embodiments described in the present disclosure can also comprise adjustable uplight bars that can be individually customized with different beam spread patterns. The beam spread patterns can be customized by placing a plurality of optic caps over the light sources located on the adjustable uplight bars. The optic caps can produce beam spread patterns at different angles, which also allows users to maneuver the uplight points as they desire. For example, the uplight bars can be maneuvered based on the distance of the lighting device to the ceiling.

Additional embodiments described in the present disclosure can comprise adjustable uplight bars with the ability to project images onto a ceiling. A physical stencil can be placed inside the light sources on the adjustable uplight bars before assembling the optic caps, which can control the shape of the emitted light. This provides the advantages of allowing a user to project graphics onto a surface, such as the ceiling. Such graphics can be a pattern, phrase, logo, or design.

Throughout this disclosure, the preferred embodiment and examples illustrated should be considered as exemplars, rather than as limitations on the present disclosure. As used herein, the term “invention,” “device,” “apparatus,” “method,” “disclosure,” “present invention,” “present device,” present apparatus,” “present method,” or “present disclosure” refers to any one of the embodiments of the disclosure described herein, and any equivalents. Furthermore, reference to various feature(s) of the “invention,” “device,” “apparatus,” “method,” “disclosure,” “present invention,” “present device,” “present apparatus,” “present method,” or “present disclosure” throughout this document does not mean that all claimed embodiments or methods must include the reference feature(s).

It is also understood that when an element or feature is referred to as being “on” or “adjacent” to another element or feature, it can be directly on or adjacent the other element or feature or intervening elements or features may also be present. In contrast, when an element is referred to as being “directly on” or extending “directly onto” another element, there are no intervening elements present. Additionally, it is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Furthermore, relative terms such as “inner,” “outer,” “upper,” “top,” “above,” “lower,” “bottom,” “beneath,” “below,” and similar terms, may be used herein to describe a relationship of one element to another. Terms such as “higher,” “lower,” “wider,” “narrower,” and similar terms, may be used herein to describe angular relationships. It is understood that these terms are intended to encompass different orientations of the elements or system in addition to the orientation depicted in the figures.

Although the terms first, second, third, etc., may be used herein to describe various elements, components, regions, and/or sections, these elements, components, regions, and/or sections should not be limited by these terms. These terms are only used to distinguish one element, component, region, or section from another. Thus, unless expressly stated otherwise, a first element, component, region, or section discussed below could be termed a second element, component, region, or section without departing from the teachings of the present disclosure. As used herein, the term “and/or” includes any and all combinations of one or more of the associated list items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. For example, when the present specification refers to “an” assembly, it is understood that this language encompasses a single assembly or a plurality or array of assemblies. It is further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

Embodiments as described in the present disclosure can be described herein with reference to view illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region and are not intended to limit the scope of the disclosure.

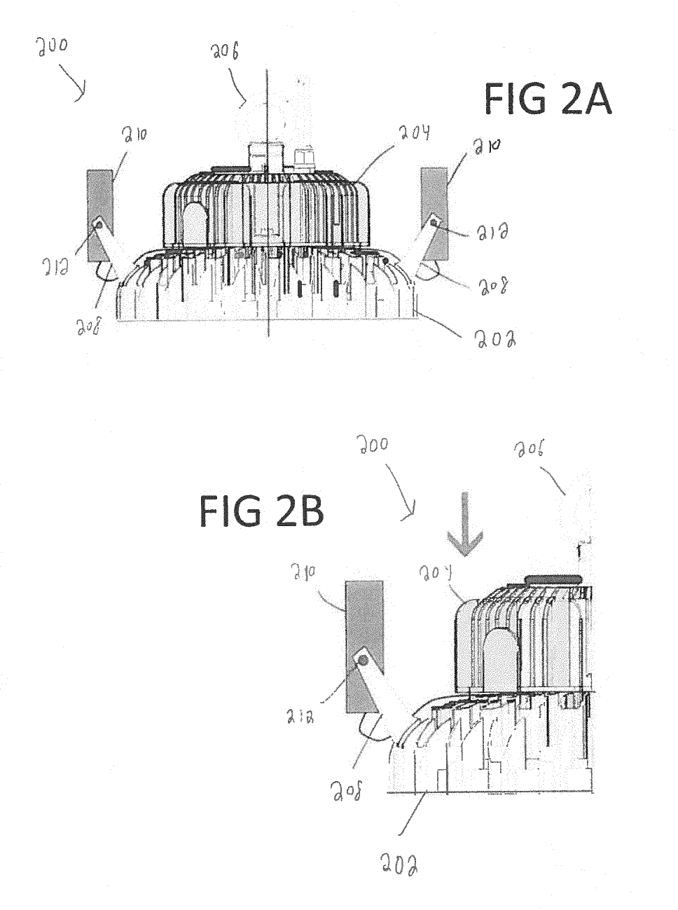

Embodiments herein can include lighting devices comprising novel and improved features. FIGS. 2A-2B show one embodiment of a lighting device 200 that can comprise a heat sink 202, a removable service panel 204, a mounting mechanism 206, arms 208, adjustable uplight bars 210, and elbow joints 212. The lighting device 200 can be a high bay lighting device, which can be advantageously used in large industrial or commercial buildings. The heat sink 202 can be integrated into a housing made of a heat conductive material, such as aluminum, steel, zinc, copper, or tin. Furthermore, the size of the heat sink 202 can be such to dissipate the heat from a high intensity light source commonly used in lighting devices, such as high bay lighting, providing superior thermal management.

The removable service panel 204 can be positioned above the heat sink 202 and can comprise a driver to power the lighting device 200. In some embodiments, the removable service panel 204 can convert an input AC voltage to an output DC voltage and can be protected by a housing, which can also be made of a heat conductive material, such as aluminum, steel, zinc, copper, or tin. The removable surface panel 204 can also comprise a dimmer, which can be automated with a motion sensor, providing the advantage of saving energy when the full amount of emitted light is not necessary. The mounting mechanism 206 can be positioned above the removable service panel 204 and can comprise multiple mounting types, such as a hook mount or a hanging bracket. Using the different mounting types, the mounting mechanism 206 can provide means to mount the lighting device 200 to a ceiling, but can also be used to mount the lighting device 200 to other areas for use in different applications.

Also shown in FIGS. 2A-2B, the lighting device 200 can comprise arms 208 connected to the heat sink 202. The arms 208 can be configured to hold the adjustable uplight bars 210 vertically upwards such that emitted light is directed upwards toward a ceiling. In some embodiments, the arms 208 can be positioned radially around the heat sink 202, such that the adjustable uplight bars 210 can provide emitted light to a larger area upwards toward the ceiling or other surface. The arms 208 can also comprise elbow joints 212 which can fit through apertures contained on the surface of the adjustable uplight bars 210. In some embodiments, the elbow joints 212 can allow an installer to maneuver the uplight points of the adjustable uplight bars based on, for example, the area in which the lighting device 200 is mounted.

Additionally, the lighting device 200 can comprise different beam spread angle options which can change the area in which light is emitted downwards from the lighting device 200. The lighting device 200 can also comprise a glare free lens cover, such as a polycarbonate lens cover. Different reflectors, such as polycarbonate and aluminum, may also be placed over the lighting device 200. The lighting device 200 can be used in a variety of places, such as in manufacturing facilities, warehouse facilities, airplane hangars, retail spaces, gymnasiums, and shopping malls.

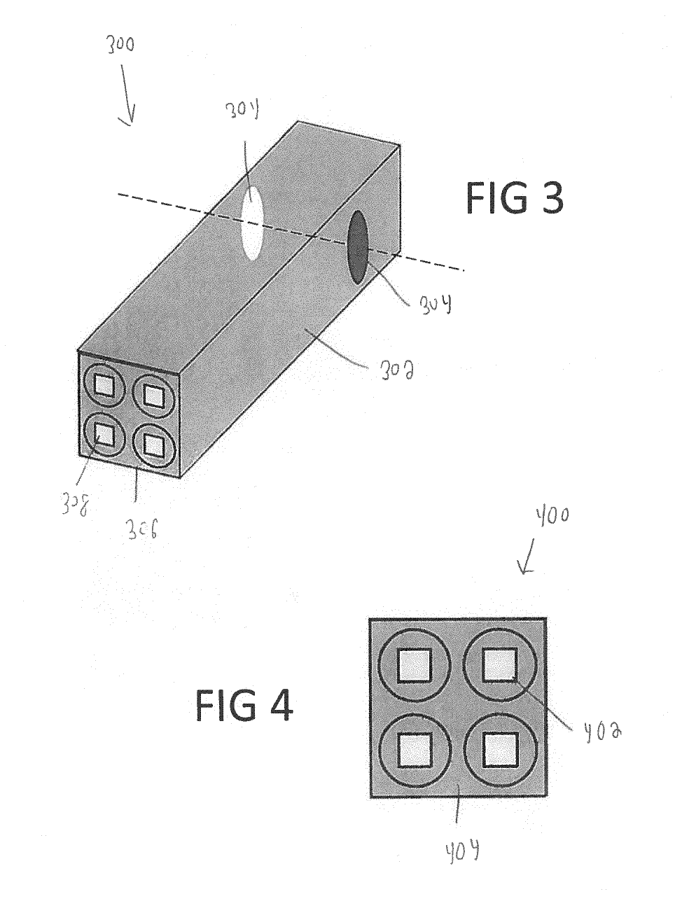

Embodiments herein can include adjustable uplight bars comprising additional novel and improved features. FIG. 3 shows an adjustable uplight bar 300 that can comprise side portions 302, apertures 304, a top portion 306, and light sources 308. The side portions 302 can comprise apertures 304 such that the elbow joints on the arms (described in FIG. 2A-2B above) can fit through the adjustable uplight bar 300, allowing the adjustable uplight bar 300 to connect to the heat sink of the lighting device. The top portion 306 of the adjustable uplight bar 300 can comprise the light sources 308. Although multiple light sources 308 can be used, one light source 308 can also be used. In some embodiments, the adjustable uplight bar 300 can be positioned such that the top portion 306 points upwards, allowing the light sources 308 to emit light upwards toward a ceiling, for example. The adjustable uplight bar 300 can be a cubic shape (shown here), a cuboid shape, a cylindrical shape, or any other similar three dimensional shape.

FIG. 4 shows another embodiment of the adjustable uplight bar 400 that can comprise light sources 402 positioned on a top portion 404 of the adjustable uplight bar 400. Although four light sources 402 are shown in FIG. 4, any number of light sources 402 can be used, including one light source 402. The light sources 402 can be solid state light sources, as such LEDs. LEDs are advantageous because they can have a significantly longer operational lifetime. For example, LEDs can have lifetimes between 50,000 and 70,000 hours. Although the increased efficiency and extended lifetime of LEDs are advantageous to many lighting suppliers, other light sources such as incandescent light bulbs or fluorescent light bulbs can be used, for example.

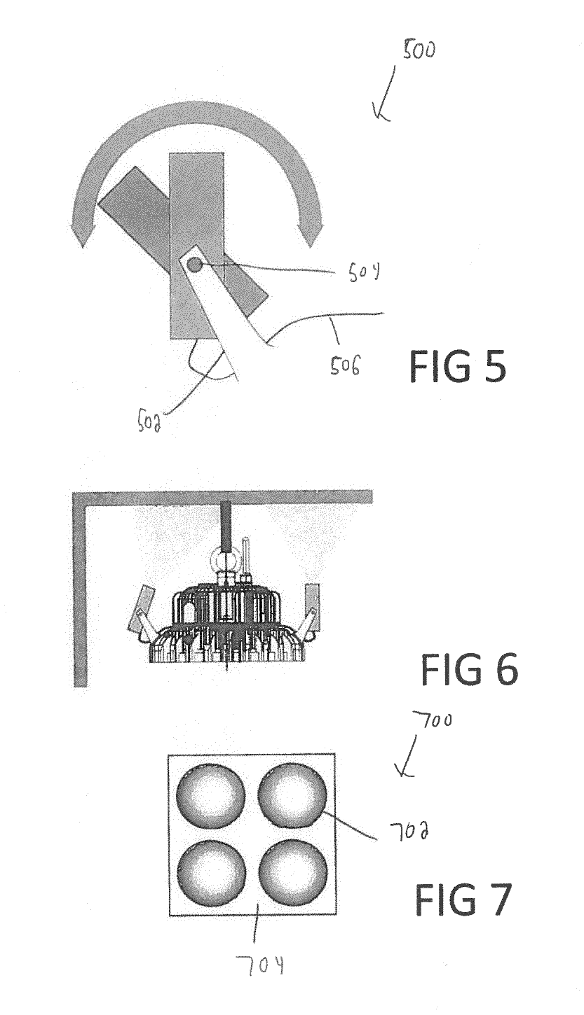

Additionally, embodiments herein can include rotatable adjustable uplight bars. FIG. 5 shows an adjustable uplight bar 500 that can comprise an arm 502, an elbow joint 504, and a pull string 506. The adjustable uplight bar 500 can be held in position by an elbow joint 504 on the arm 502. The elbow joint 504 can allow the adjustable uplight bar 500 to be maneuvered as desired by a user. For example, as shown by the arrow in FIG. 5, the adjustable uplight bar 500 can be rotated in either direction, which changes the direction the light sources point on the adjustable uplight bar 500. In some embodiments, the user can pull on the pull string 506 to more easily rotate the adjustable uplight bar 500. This provides the advantage of allowing the user to individually customize the uplight bars.

For example, each uplight bar can be individually customized to provide desired visuals, such as uplight bars pointed toward a specific point in a set pattern. In other examples, each uplight bar can be individually customized to accommodate different mounting areas. FIG. shows one example of a lighting device mounted in a corner, in which one uplight bar is rotated to point diagonally away from the corner, providing more lighting upwards and not onto the side wall.

Embodiments herein can also include adjustable uplight bars with optic caps. FIG. 7 shows an adjustable uplight bar 700 that can comprise optic caps 702 positioned on a top portion 704 of the adjustable uplight bar 700. Each optic cap 702 can be positioned over each light source as described in FIG. 4 (not shown in FIG. 7). The optic caps 702 can each be individually customized to produce different beam spread patterns. This provides the advantage of providing another way for a user to individually customize the uplight bars.

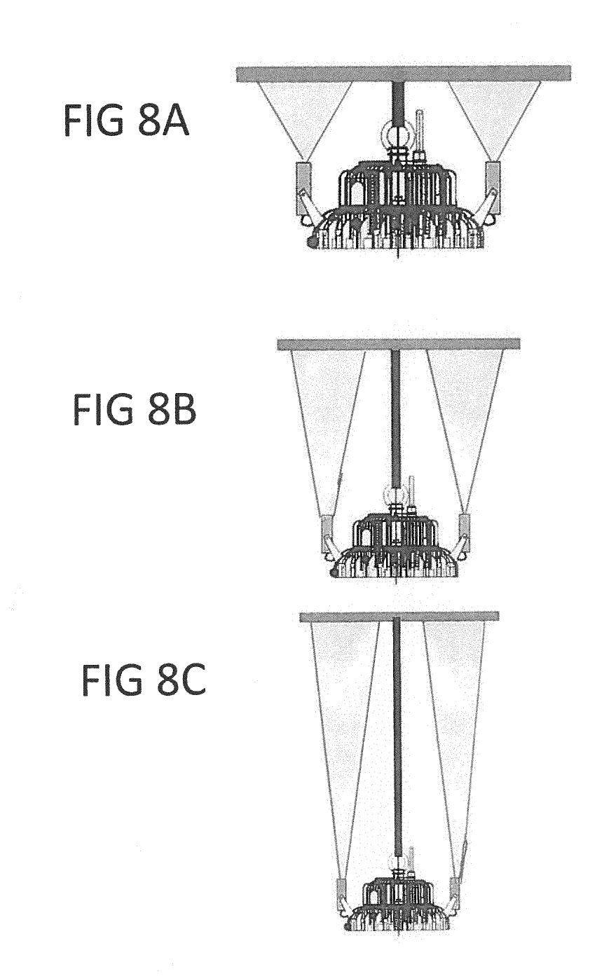

For example, different beam spread patterns can be used depending on the distance of the lighting device to the ceiling. FIG. 8A shows one example of a beam spread pattern of 30 degrees, wherein the lighting device is positioned a close distance away from the ceiling. FIG. 8C shows another example of a beam spread pattern of 15 degrees, wherein the lighting device is positioned a far distance away from the ceiling. Finally, FIG. 8B shows yet another example of a beam spread pattern of 22 degrees, wherein the lighting device is positioned at a distance from the ceiling between the two distances shown in FIGS. 8A and 8C. FIG. 8A-8C are only meant to be examples; different beam spread patterns can be used other than 15, 22, and 30 degrees.

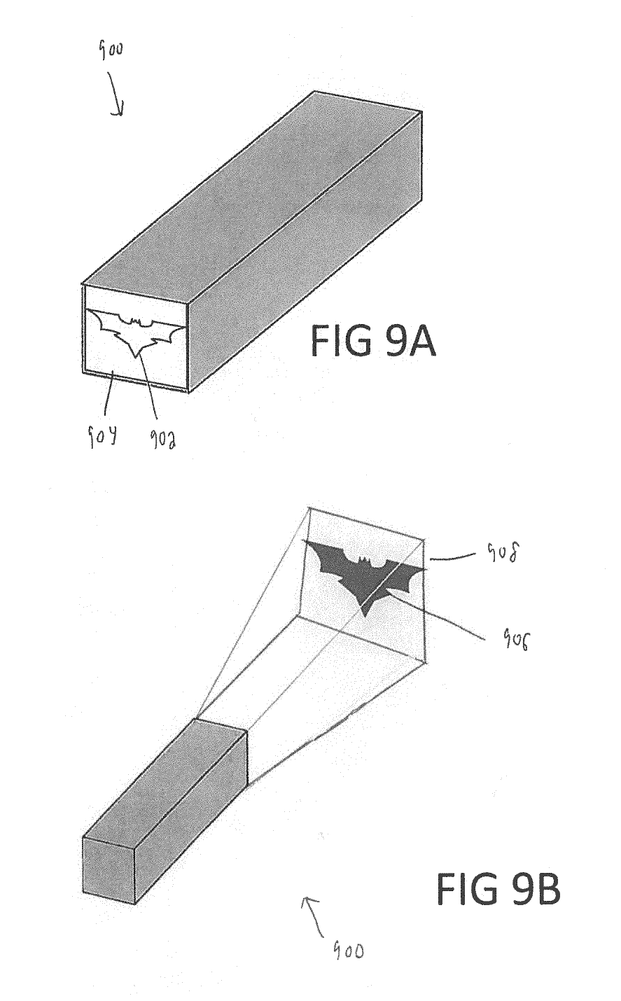

Embodiments herein can also include adjustable uplight bars that can be configured to project graphics onto a surface, such as a ceiling. FIGS. 9A-9B show an adjustable uplight bar 900 that can comprise a stencil 902, a top portion 904, an image 906, and a surface 908. The stencil 902 can be placed inside the light sources before assembling the optic caps, which can act to control the shape of the emitted light. The emitted light can project an image 906 onto a surface 908. In some embodiments, the image 906 can be a graphic or graphics, such as a logo, a short phrase, a pattern, or a design. The surface 908 can be a ceiling where the image 906 may be displayed, but can also be another surface such as a wall, a floor, or a flat object.

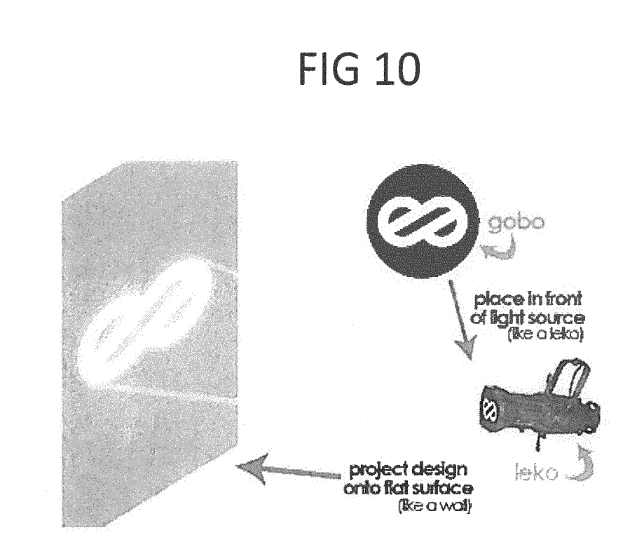

In some embodiments, the stencil 902 can be a Goes Before Optics (“GOBO”). FIG. 10 shows one embodiment of a GOBO used with an adjustable uplight bar. GOBOs can be designed with patterned holes that allows only the desired shape or pattern of light through, casting a specific pattern of light and shadow into the space. This can allow a user to create wide variety of shapes with the emitted light. GOBOs may be used, in connection with projectors and simpler light sources, to create lighting scenes in a theatrical application. Simple GOBOs, incorporated into automated lighting systems, are popular at nightclubs and other musical venues to create moving shapes. In some embodiments, GOBOs may also be used for architectural lighting, as well as in interior design, as in projecting a company logo on a wall or other feature. GOBOs can be made from various materials, include steel, glass, and/or plastic.

It is understood that embodiments presented herein are meant to be exemplary. Embodiments of the present disclosure can comprise any combination or compatible features shown in the various figures, and these embodiments should not be limited to those expressly illustrated and discussed.

Although the present disclosure has been described in detail with reference to certain configurations thereof, other versions are possible. Therefore, the spirit and scope of the disclosure should not be limited to the versions described above.

The foregoing is intended to cover all modifications and alternative constructions falling within the spirit and scope of the disclosure as expressed in the appended claims, wherein no portion of the disclosure is intended, expressly or implicitly, to be dedicated to the public domain if not set forth in the claims.

We claim:

1. A ceiling mounted lighting device, comprising:
a housing;
a mounting mechanism attached to said housing for mounting said lighting device to a ceiling;
solid state lighting devices arranged within said housing to illuminate the area below said lighting device;
a plurality of uplights adjustably mounted to said housing and comprising uplight solid state light sources to illuminate the ceiling above said lighting device, wherein the illumination provided by said uplights can be adjusted to illuminate different areas of the ceiling above said lighting device.

2. The lighting device of claim 1, wherein said uplights comprise a plurality of uplight bars.

3. The lighting device of claim 2, wherein said uplight bars are movably mounted to said housing to direct emission from said uplight bars to the desired area of said ceiling above said lighting device.

4. The lighting device of claim 2, wherein said solid state light sources within said uplight bars are movable to direct emission from said uplight bars to the desired area of said lighting device.

5. The lighting device of claim 2, further comprising a plurality of arms each having a first and second end, and each of which is attached at said first end to said housing and having a respective one of said uplight bars attached to said second end.

6. The lighting device of claim 1, wherein said uplight are mounted to said housing by elbow joints.

7. The lighting device of claim 1, wherein said housing further comprises a heat sink.

8. The lighting device of claim 1, further comprising a dimmer to adjust the emission intensity from said lighting device.

9. The lighting device of claim 2, comprising a mechanical device to adjust the emission direction of said uplights bars.

10. The lighting device of claim 2, wherein each uplight bar has a string to adjust the emission direction of said uplight bars.

11. The lighting device of claim 1, further comprising optical caps over said uplight solid state light sources.

12. The lighting device of claim 1, further comprising a stencil over said uplights to generate the desired emission pattern.

13. The lighting device of claim 12, wherein said stencil comprises a Goes Before Optics (“GOBO”) stencil.

14. A ceiling mounted lighting device, comprising:
a heat sink;
a mounting mechanism attached to said heat sink for mounting said lighting device to a ceiling;
device light emitting diodes in thermal communication with said heat sink arranged to illuminate the area below said lighting device;
a plurality of uplights bars mounted to said heat sink, each comprising uplight light emitting diodes arranged to illuminate the ceiling above said lighting device, each of said uplight bars movably mounted to said heat sink to illuminate the desired area of said ceiling above said lighting device.

15. The lighting device of claim 14, further comprising a plurality of arms each having a first and second end, and each of which is attached at said first end to said heat sink and having a respective one of said uplight bars attached to said second end.

16. The lighting device of claim 14, further comprising a dimmer to adjust the emission intensity from said lighting device.

17. The lighting device of claim 14, comprising a mechanical device to adjust the emission direction of said uplights bars.

18. The lighting device of claim 14, further comprising optical caps over said uplight solid state light sources.

19. The lighting device of claim 14, further comprising a stencil over said uplights to generate the desired emission pattern.

20. A ceiling mounted lighting system, comprising:
a plurality of ceiling mounted lighting devices, at least some of which comprise;
a housing having a heat sink;
a mounting mechanism attached to said housing for mounting said lighting device to a ceiling;
device light emitting diodes mounted in said housing and in thermal communication with said heat sink arranged to illuminate the area below said lighting device;
a plurality of uplights bars each comprising uplight light emitting diodes arranged to illuminate the ceiling above said lighting device, each of said uplight bars movably mounted to said heat sink to illuminate the desired area of said ceiling above said lighting device.
